(19) United States
(12) Patent Application Publication
(10) Pub. No.: US 2018/0241894 A1
(43) Pub. Date: Aug. 23, 2018

(54) IMAGE PROCESSING APPARATUS, CONTROL METHOD THEREFOR, AND CONTROL PROGRAM THEREFOR

(71) Applicant: CANON KABUSHIKI KAISHA, Tokyo (JP)

(72) Inventor: Takayuki Shimizu, Kawasaki-shi (JP)

(21) Appl. No.: 15/956,246

(22) Filed: Apr. 18, 2018

Related U.S. Application Data
(63) Continuation of application No. 14/027,110, filed on Sep. 13, 2013.
Application No. 14/027,110 is a division of application No. 11/178,365, filed on Jul. 12, 2005, now abandoned.

(30) Foreign Application Priority Data
Jul. 16, 2004 (JP) 2004-210381

(51) Int. Cl. H04N 1/00; G06F 3/12; H04N 1/32

(52) U.S. Cl. CPC H04N 1/00442; H04N 1/00244; H04N 1/32101; H04N 2201/0094; H04N 2201/3245; G06F 3/1288

(57) ABSTRACT

This specification discloses a more convenient image processing apparatus capable of printing a document in a document management server. More specifically, the image processing apparatus is a digital multifunction peripheral having a display unit which lists and displays documents managed in the document management server, and a printer which selectively prints displayed documents. A controller unit compares print settings added to the documents managed in the document management server with the printing functions of the printer, and masks and displays a document (1000) to which a print setting unimplementable by the printing functions of the printer is added, thereby easily identifying the document (1000) from other documents (1001, 1002).

### FIELD OF THE INVENTION

The present invention relates to an image processing apparatus, control method therefor, and control program therefor.

### BACKGROUND OF THE INVENTION

There has conventionally been known an image processing apparatus capable of listing and displaying documents managed by a document management server and selectively printing them. For example, Japanese Patent Laid-Open No. 2003-316773 proposes a network document management system constructed by connecting a document management server and digital multifunction peripheral via a network. The document management server stores document information (e.g., document image data created by reading printed characters, figures, images, or the like by a scanner or the like, or document data created by a word processor or the like) in association with document addition information (e.g., a keyword). The digital multifunction peripheral searches for, displays, and prints these pieces of information.

Some of proposed network document management systems can print document information stored in the document management server by operation via the operation window of the digital multifunction peripheral. In accordance with operation via the operation window, the digital multifunction peripheral can store, as document information in the document management server, image data generated by reading a document by a scanner. The digital multifunction peripheral can also acquire document information stored in the document management server, and cause a printer to print it.

However, the conventional network document management system is not always convenient when pieces of document information are listed and displayed in the digital multifunction peripheral. This is because the system does not comprise any image processing apparatus which discriminately display document information having a print setting which becomes invalid in printing and document information having no invalid print setting. It is very cumbersome to determine whether desired document information has a print setting which becomes invalid in printing. For example, desired document information is selected, and then the display is switched to a print setting window to confirm print settings of the document information. Alternatively, printing of the document information is actually executed to confirm an error message or a printed result.

### SUMMARY OF THE INVENTION

The present invention enables to provide a more convenient image processing apparatus capable of printing a document in a document management server.

One aspect of the present invention is an image processing apparatus comprising a display unit adapted for displaying information for identifying documents managed in a document management server, a print unit adapted for selectively printing at least one of the documents managed in the document management server, and a controller for comparing print settings added to the documents managed in the document management server with a printing function of the print unit, wherein the display unit displays information for identifying a document to which a print setting unimplementable by the printing function of the print unit is added, identifiably from a document to which a print setting unimplementable by the printing function of the print unit is not added.

Other features and advantages of the present invention will be apparent form the following description taken in conjunction with the accompanying drawings, in which like reference characters designate the same or similar parts throughout the figures thereof.

### BRIEF DESCRIPTION OF THE DRAWINGS

FIG. 1 is a block diagram showing the overall configuration of a network document management system according to the first embodiment of the present invention;

FIG. 2 is a block diagram showing the functional configurations of the document management client and document management server of the system;

FIG. 3 is a view showing an example of a table definition in the attribute storage unit of the document management server;

FIG. 4 is a view showing an example of the data structure in the volume storage unit of the document management server;

FIG. 5 is a block diagram showing the configuration of the digital multifunction peripheral of the system;

FIG. 6 is a view showing the arrangement of the operation unit of the digital multifunction peripheral;

FIG. 7 is a block diagram showing the functional configuration of system software of the digital multifunction peripheral;

FIG. 8 is a flowchart for explaining a document addition information acquisition/response process in the document management server of the system;

FIG. 9 is a flowchart for explaining a document information listing process in the digital multifunction peripheral of the system;

FIG. 10 is a view showing an example of the display window of attribute data in the document information listing process;

FIG. 11 is a view showing an example of the display window of attribute data and thumbnail image information in the document information listing process;

FIG. 12 is a flowchart showing the flow of a process in a digital multifunction peripheral according to the second embodiment of the present invention;

FIG. 13 is a view showing an example of a display window in the digital multifunction peripheral according to the second embodiment of the present invention;

FIG. 14 is a flowchart showing the flow of another process in the digital multifunction peripheral according to the second embodiment of the present invention;

FIG. 15 is a view showing another example of the display window in the digital multifunction peripheral according to the second embodiment of the present invention;

FIG. 16 is a view showing an example of a table definition in the attribute storage unit of a document management server according to the third embodiment of the present invention;

FIG. 17 is a flowchart showing the flow of a process in the document management server according to the third embodiment of the present invention;

FIG. 18 is a flowchart showing the flow of a process in a digital multifunction peripheral according to the third embodiment of the present invention;

FIG. 19 is a view showing an example of a display window in the digital multifunction peripheral according to the third embodiment of the present invention;

FIG. 20 is a flowchart showing the flow of another process in the digital multifunction peripheral according to the third embodiment of the present invention; and

FIG. 21 is a view showing another example of the display window in the digital multifunction peripheral according to the third embodiment of the present invention.

### DETAILED DESCRIPTION OF THE PREFERRED EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

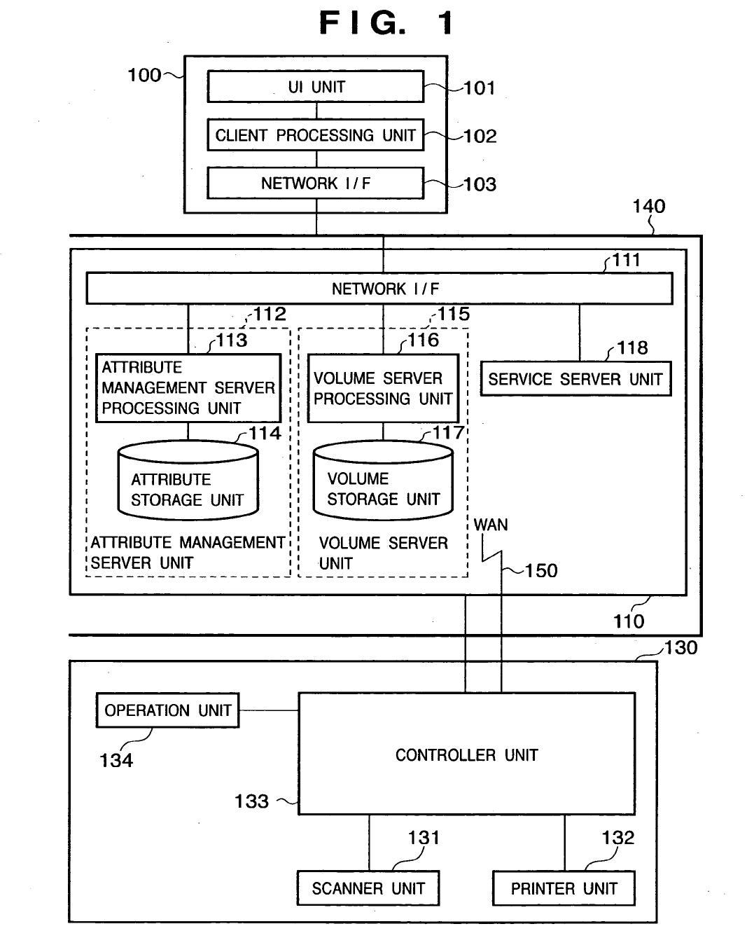

FIG. 1 is a block diagram for explaining the overall configuration of a network document management system according to the first embodiment of the present invention. The network document management system comprises a document management client 100, document management server 110, and digital multifunction peripheral 130, and these components are connected via a network 140.

The document management client 100 is a client of the network document management system that searches for and displays document information managed by the document management server 110. The document management client 100 comprises a UI (User Interface) unit 101, client processing unit 102, and network I/F 103. The UI unit 101 accepts instructions from the operator that pertain to functions (e.g., registration, search, and display of document information) of the document management client 100. The UI unit 101 provides the operator with various pieces of information such as the process result of an instruction. The UI unit 101 is made up of a display device typified by a CRT, liquid crystal display, or the like, and an input device including a keyboard and pointing device. The client processing unit 102 is made up of a CPU, memory, and the like, and performs processes of functions (e.g., registration, search, and display of document information) of the document management client 100. When a process to the document management server 110 is generated, the client processing unit 102 transmits various request commands to the document management server 110 via the network I/F 103, and receives the responses.

The document management server 110 is a server of the network document management system that manages image data and document data stored in the document management client 100 or digital multifunction peripheral 130. The document management server 110 comprises a network I/F 111, attribute management server unit 112, volume server unit 115, and service server unit 118. The attribute management server unit 112, volume server unit 115, and service server unit 118 may be formed from one personal computer, like the embodiment, or from separate personal computers connected via the network 140.

The network I/F 111 is connected to the network 140, and performs processes of network protocols such as TCP/IP.

The attribute management server unit 112 manages the inclusion relation between a folder, a document, and a page and their attributes so as to manage image data and document data as documents stored in a hierarchical folder. The attribute management server unit 112 is formed from an attribute management server processing unit 113 and attribute storage unit 114. The attribute management server processing unit 113 is made up of a CPU, memory, and the like. The attribute management server processing unit 113 receives a request command from the client processing unit 102 or service server unit 118 via the network I/F 111, performs processes such as updating and search to the attribute storage unit 114, and transmits the process results to the client processing unit 102 or service server unit 118. The attribute storage unit 114 stores a folder attribute, document attribute, page attribute, and the like, and is generally formed from a hard disk or the like.

The volume server unit 115 stores and manages actual data such as document data and image data which are made by the attribute management server unit 112 to correspond to pages. The volume server unit 115 is formed from a volume server processing unit 116 and volume storage unit 117. The volume server processing unit 116 is made up of a CPU, memory, and the like. The volume server processing unit 116 receives a request command from the client processing unit 102 or service server unit 118 via the network I/F 111, performs processes such as updating and data acquisition to the volume storage unit 117, and transmits the process results to the client processing unit 102 or service server unit 118. The volume storage unit 117 stores document data and image data, and is generally formed from a hard disk or the like.

The service server unit 118 is made up of a CPU, memory, or the like. The service server unit 118 receives a request command from the digital multifunction peripheral 130 via the network I/F 111, and performs processes requested by the digital multifunction peripheral 130. When a process (e.g., registration of document information, updating of an attribute, or search) to the attribute management server unit 112 or volume server unit 115 is generated, the service server unit 118 transmits various request commands to the attribute management server unit 112 or volume server unit 115 via the network I/F 111, receives the responses, and transmits the process results to the digital multifunction peripheral 130.

The digital multifunction peripheral 130 is an image forming apparatus having multiple functions of a copying machine, scanner, printer, and FAX apparatus.

The digital multifunction peripheral 130 comprises a scanner unit 131 serving as an image input device, a printer unit 132 serving as an image output device, a controller unit 133, and an operation unit 134 serving as a user interface. The scanner unit 131, printer unit 132, and operation unit 134 are connected to the controller unit 133, and the controller unit 133 is connected to the network (LAN) 140 and a public circuit (WAN) 150.

The controller unit 133 executes processes such as a print job on the basis of information input from the operation unit 134, and provides the operation unit 134 with information on the device status and job status. When a process to the document management server 110 is generated, the controller unit 133 transmits a request command to the service server unit 118, receives the response, and provides the operation unit 134 with information acquired from the document management server 110.

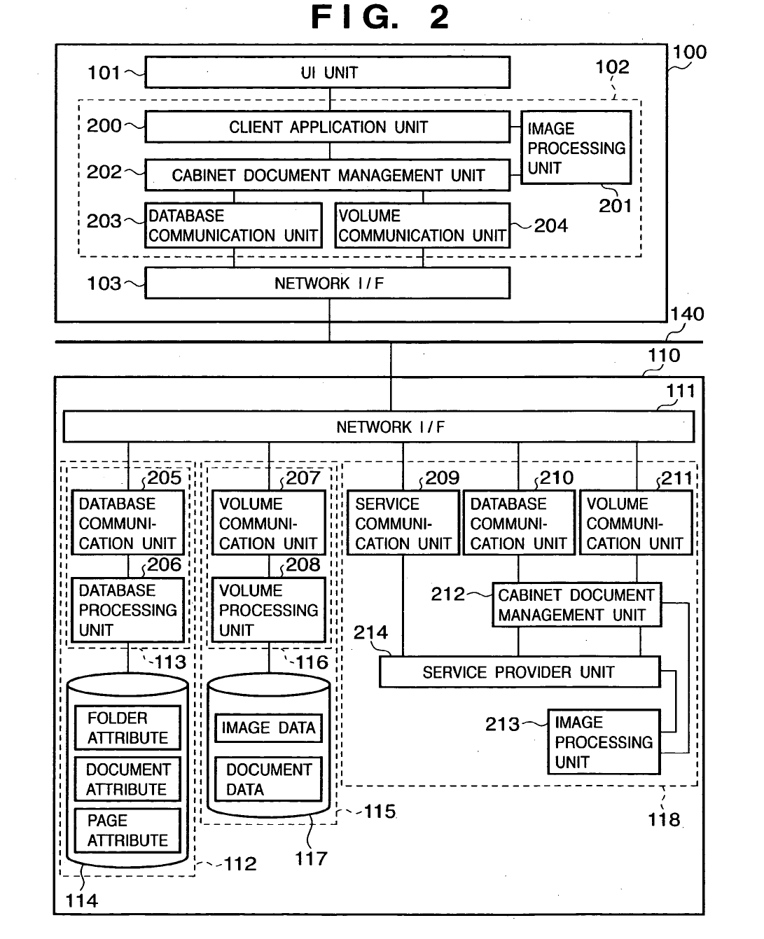

FIG. 2 is a block diagram showing the functional configurations of the document management client and document management server shown in FIG. 1. The same reference numerals as those in FIG. 1 denote the same parts.

The client processing unit 102 of the document management client 100 comprises a client application unit 200, image processing unit 201, cabinet document management unit 202, database communication unit 203, and volume communication unit 204. The client application unit 200 performs processes of functions of the document management client 100 in accordance with an instruction from the UI unit 101, and controls the display window of the UI unit 101. When a process to the attribute management server unit 112 or volume server unit 115 is generated, the client application unit 200 supplies the request to the cabinet document management unit 202, and receives the process result from the cabinet document management unit 202. The image processing unit 201 executes image processes (e.g., decompression/compression of image data, color space conversion, undercolor removal, enlargement/reduction, and rotation) in accordance with requests from the client application unit 200 and cabinet document management unit 202. The cabinet document management unit 202 implements requests to the attribute management server unit 112 and volume server unit 115 by an object model made up of a cabinet, folder, document, and page. When a process such as reference or updating of a folder attribute, document attribute, or page attribute, the cabinet document management unit 202 supplies the request to the database communication unit 203, and receives the process result from the database communication unit 203. When a process such as registration, deletion, or acquisition of image data or document data is generated, the cabinet document management unit 202 supplies the request to the volume communication unit 204, and receives the process result from the volume communication unit 204. The database communication unit 203 transmits, to a database communication unit 205 via the network I/F 103, a request command to the attribute management server unit 112 by the SQL (Structured Query Language) protocol defined on the TCP/IP protocol, and receives the response command from the database communication unit 205. The volume communication unit 204 transmits, to a volume communication unit 207 via the network I/F 103, a request command to the volume server unit 115 by RPC (Remote Procedure Call), and receives the response command from the volume communication unit 207.

The attribute management server processing unit 113 of the document management server 110 comprises the database communication unit 205 and a database processing unit 206. When the database communication unit 205 receives a request command to the attribute management server unit 112 from the database communication unit 203 or a database communication unit 210 via the network I/F 111 by the SQL (Structured Query Language) protocol defined on the TCP/IP protocol, the database communication unit 205 supplies the request to the database processing unit 206, and transmits the process result as a response command to the database communication unit 203 or database communication unit 210. The database processing unit 206 is an RDBMS (Relational Database Management System) for managing the inclusion relation between a folder, a document, and a page and their attributes, and performs processes such as updating and search to the attribute storage unit 114 serving as a database file.

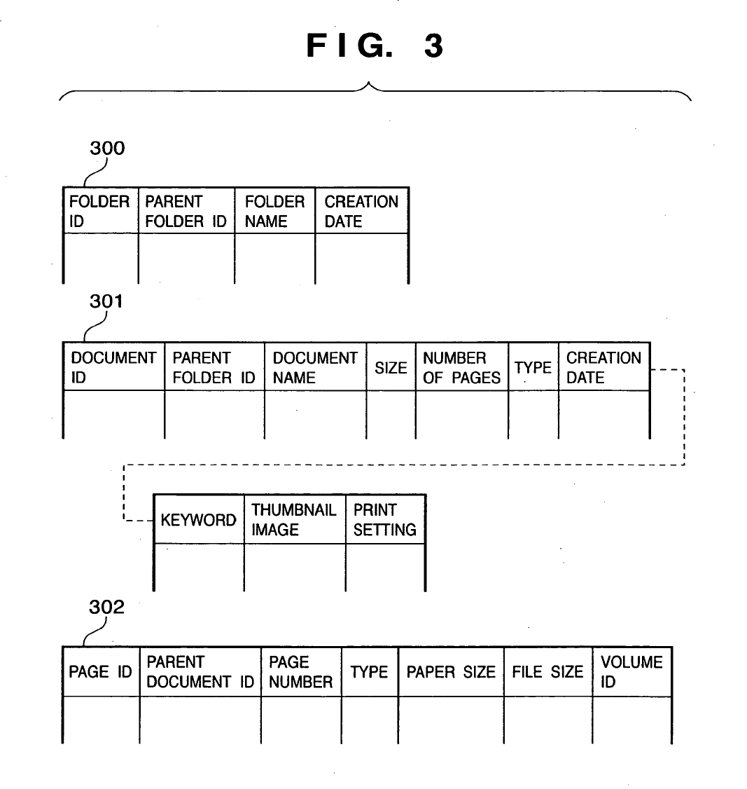

FIG. 3 shows an example of a table definition in the attribute storage unit 114 that is used to manage the inclusion relation between a folder, a document, and a page and their attributes by the database processing unit 206. A folder management table 300 is made up of a folder ID for identifying a folder, a parent folder ID for identifying a parent folder, a folder name, and a creation date. A document management table 301 is made up of a document ID for identifying a document, a parent folder ID for identifying a parent folder, a document name, size, the number of pages, a document type for identifying whether a document is an image document as a set of image data or document data of a given application, a creation date, a keyword for searching for a document, thumbnail image data of the first page, and print setting information. The print setting information contains printing method information representing settings such as single-sided printing, double-sided printing, and bookbinding printing, delivery method information representing settings such as rotation, shift, stapling, saddle stitch, punching, and Z-folding, and sheet feed method information representing settings such as the paper size and insertion of an index sheet. A page management table 302 is made up of a page ID for identifying a page, a parent document ID for identifying a parent document, a page number, a page type for identifying the file format of page data, a paper size for identifying the paper size of image data, file size, image data managed by the volume server unit 115, and a volume ID for identifying document data.

The volume server processing unit 116 of the document management server 110 comprises the volume communication unit 207 and a volume processing unit 208. When the volume communication unit 207 receives a request command to the volume server unit 115 by RPC (Remote Procedure Call) from the volume communication unit 204 or a volume communication unit 211 via the network I/F 111, the volume communication unit 207 supplies the request to the volume processing unit 208, and transmits the process result as a response command to the volume communication unit 204 or volume communication unit 211. The volume processing unit 208 performs processes such as updating and data acquisition to the volume storage unit 117 serving as a volume file.

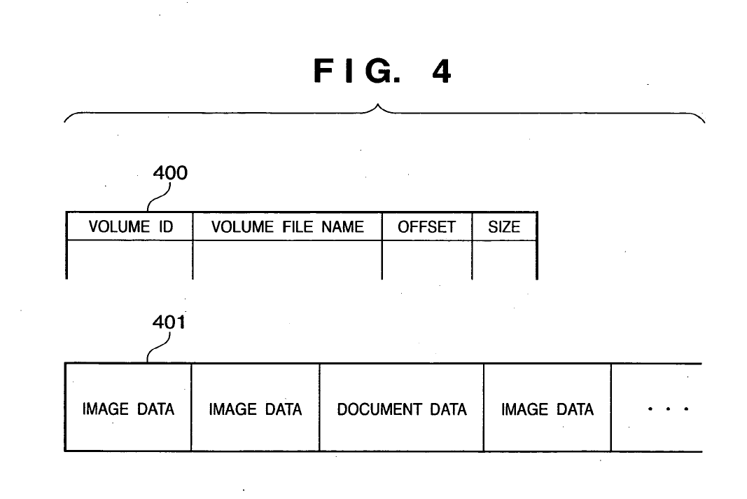

FIG. 4 shows an example of the data structure in the volume storage unit 117 that is used to add and acquire image data and document data by the volume processing unit 208. A volume management file 400 is made up of a volume ID for identifying data, a file name for identifying a volume storage file which stores data, an offset serving as the storage start position of data, and data size. A volume storage file 401 successively stores actual image data and document data.

The service server unit 118 of the document management server 110 comprises a service communication unit 209, the database communication unit 210, the volume communication unit 211, a cabinet document management unit 212, an image processing unit 213, and a service provider unit 214. When the service communication unit 209 receives a request command to the document management server 110 by the SOAP protocol on the HTTP protocol from the digital multifunction peripheral 130 via the network I/F 111, the service communication unit 209 supplies the request to the service provider unit 214, and transmits the process result as a response command to the digital multifunction peripheral 130. The service provider unit 214 executes a process in accordance with a request from the service communication unit 209, and sends back the process result. When a process (e.g., registration of document information, updating of an attribute, or search) to the attribute management server unit 112 or volume server unit 115 is generated, the service provider unit 214 supplies the request to the cabinet document management unit 212, and receives the process result from the cabinet document management unit 212. The functional configurations of the database communication unit 210, volume communication unit 211, cabinet document management unit 212, and image processing unit 213 are the same as those in the document management client described above, and a description thereof will be omitted.

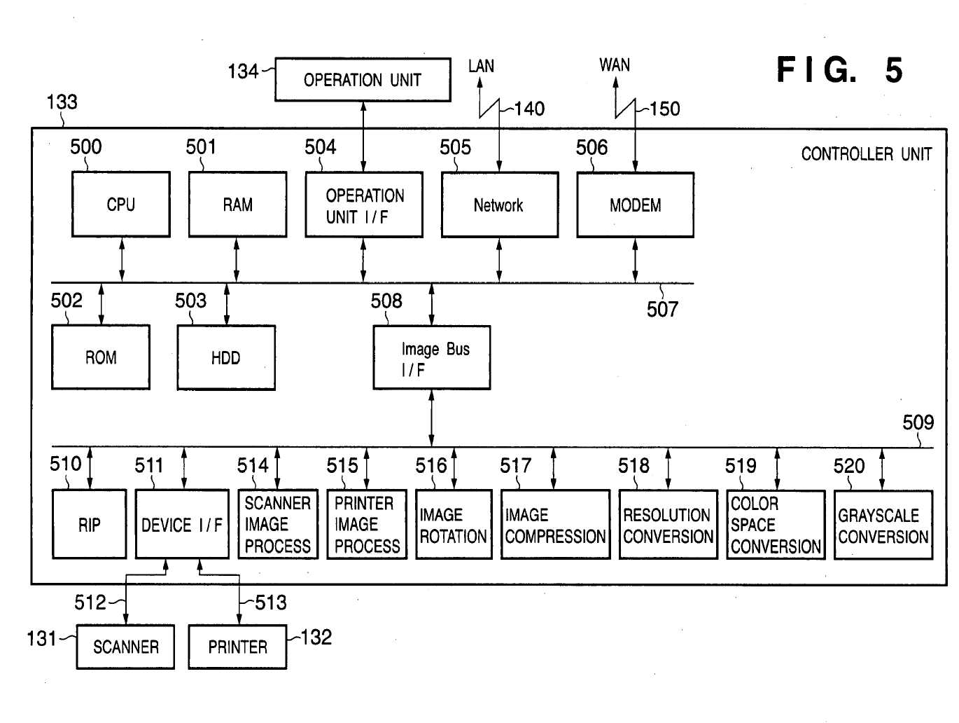

FIG. 5 is a block diagram showing the hardware configuration of the digital multifunction peripheral 130 shown in FIG. 1. The same reference numerals as those in FIG. 1 denote the same parts. The controller unit 133 is connected to the scanner unit 131 serving as an image input device and the printer unit 132 serving as an image output device, and also connected to the network (LAN) 140 and public circuit (WAN) 150. The controller unit 133 inputs/outputs image information and device information.

In the controller unit 133, reference numeral 500 denotes a CPU which controls the whole system. Reference numeral 501 denotes a RAM which is a system work memory for operating the CPU 500 and is also an image memory (buffer memory) for temporarily storing input image data. Reference numeral 502 denotes a ROM which is a boot ROM and stores the boot program of a system. Reference numeral 503 denotes an HDD (Hard Disk Drive) which stores system software and image data.

Reference numeral 504 denotes an operation unit I/F which is an interface with the operation unit 134 and outputs image data to be displayed on the operation unit 134 to the operation unit 134. The operation unit I/F 504 transmits information input by the operator via the operation unit 134 to the CPU 500.

Reference numeral 505 denotes a network unit which is connected to the network (LAN) 140 and inputs/outputs information. Reference numeral 506 denotes a modem which is connected to the public circuit (WAN) 150 and inputs/outputs image information. These devices are arranged on a system bus 507.

Reference numeral 508 denotes an image bus I/F serving as a bus bridge which connects the system bus 507 and an image bus 509 for transferring image data at a high speed, and converts a data structure. The image bus 509 is formed from a PCI bus or IEEE 1394, and the following devices are arranged on the image bus 509.

Reference numeral 510 denotes a raster image processor (RIP) which rasterizes a PDL code into a bitmap image. Reference numeral 511 denotes a device

I/F which connects the scanner unit 131 and printer unit 132 serving as image input/output devices to the controller unit 133 via an image input unit interface 512 and printing unit interface 513, and converts the synchronous system/asynchronous system of image data.

Reference numeral 514 denotes a scanner image processing unit which corrects, processes, and edits input image data. The scanner image processing unit 514 has a function of determining from the color saturation signal of image data whether input image data is a color document or monochrome document, and holding the determination result. Reference numeral 515 denotes a printer image processing unit which corrects, processes, and edits output image data.

Reference numeral 516 denotes an image rotation unit which rotates image data and stores it in the memory at the same time as read of an image from the scanner unit 131 in cooperation with the scanner image processing unit 514, rotates image data in the memory and stores it in the memory, or prints out image data in the memory while rotating it in cooperation with the printer image processing unit 515. Reference numeral 517 denotes an image compression unit which compresses/decompresses multilevel image data by JPEG and image data of a binary image by JBIG, MMR, MR, or MH. Reference numeral 518 denotes a resolution conversion unit which converts the resolution of image data in the memory, and stores the data in the memory. Reference numeral 519 denotes a color space conversion unit which converts, e.g., YUV image data in the memory into Lab image data by matrix operation, and stores the data in the memory. Reference numeral 520 denotes a grayscale conversion unit which converts 8-bit image data of 256 gray levels into two tone levels for 1 bit by a method such as error diffusion, and stores the converted data in the memory. The image rotation unit 516, image compression unit 517, resolution conversion unit 518, color space conversion unit 519, and grayscale conversion unit 520 can operate in cooperation with each other, and when, for example, image rotation and resolution conversion are to be done for image data in the memory, can perform these processes without the mediacy of the memory.

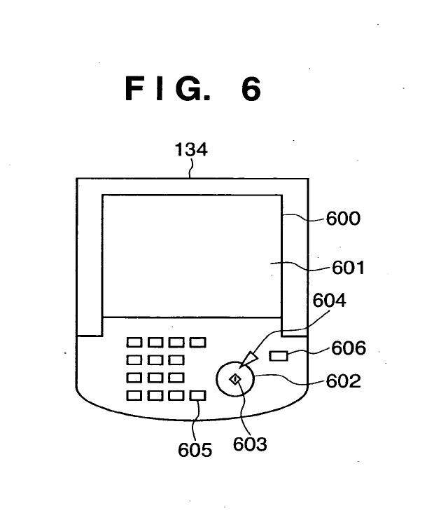

FIG. 6 shows the arrangement of the operation unit 134. A touch panel sheet 601 is adhered onto the LCD of an LCD display unit 600. The LCD display unit 600 displays the operation window of the system and soft keys, and when a displayed key is touched, transmits the position information to the CPU 500 in the controller unit 133. A start key 602 is used to start read of a document image. An LED 603 of two, green and red colors is attached to the center of the start key 602, and the color represents whether the start key 602 is available. A stop key 604 stops operation in progress. An ID key 605 is used to input the user ID of the user. A reset key 606 is used to initialize settings from the operation unit.

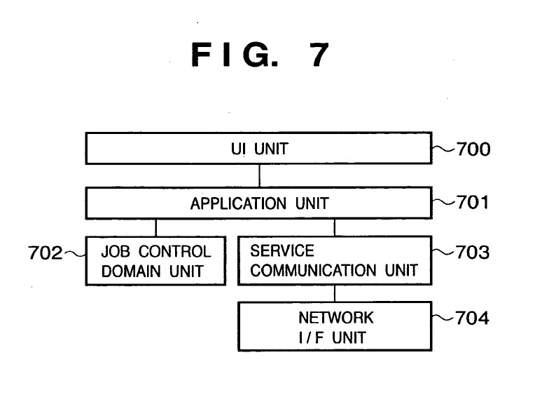

FIG. 7 is a block diagram showing the functional configuration of system software in the controller unit 133 of the digital multifunction peripheral 130 shown in FIG. 1. A UI (User Interface) unit 700 supplies input information from the operator to an application unit 701, receives the process result from the application unit 701, and generates a window to be displayed on the operation unit 134. The application unit 701 executes a process in accordance with a request from the UI unit 700. When printing is requested, the application unit 701 issues a print job to a job control domain unit 702 together with designated print settings, and receives information on the device status, job status, and the like from the job control domain unit 702. When access to the document management server 110 is requested, the application unit 701 supplies the request to a service communication unit 703, and receives the process result. The job control domain unit 702 processes a plurality of jobs such as a scan job, copy job, print job, and FAX job. When a print job is issued, the job control domain unit 702 operates the printer unit 132 on the basis of designated print settings to print image data. The job control domain unit 702 supplies, to the application unit 701 in accordance with a request from the application unit 701, printing function information representing the number of finishers and whether printing functions (e.g., double-sided printing, rotation, shift, stapling, saddle stitch, punching, Z-folding, and insertion of an index sheet) are available. The service communication unit 703 transmits a request command to the document management server 110 by the SOAP protocol on the HTTP protocol to the service communication unit 209 in the document management server 110 via a network I/F 704, and receives the response. The network I/F 704 is connected to the network 140, and performs processes of network protocols such as TCP/IP.

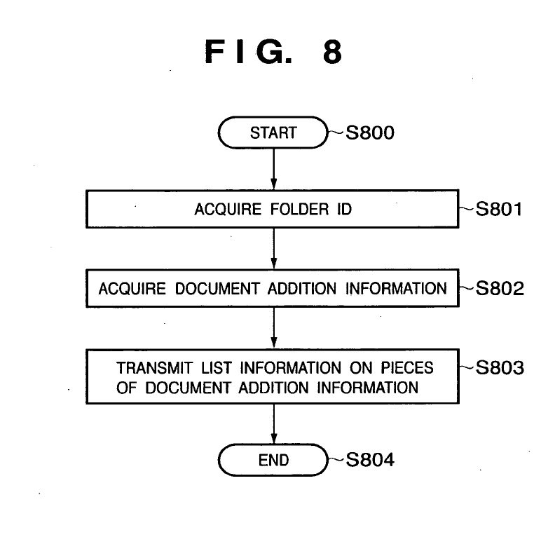

Operation of a document addition information acquisition/response process in the document management server 110 will be explained with reference to the flowchart of FIG. 8.

The document management server 110 starts the process upon reception of a document addition information acquisition request command from the digital multifunction peripheral 130 (step S800). The document management server 110 acquires a folder ID from the acquisition request command (step S801). The document management server 110 acquires attribute data and print setting information of a document that are stored in association with the acquired folder ID (step S802). As a response command to the document addition information acquisition request command received in step S800, the document management server 110 transmits, to the digital multifunction peripheral 130, list information on pieces of document addition information each containing attribute data and print setting information (step S803). Then, the process ends (step S804).

Attribute data of a document includes the type, document name, size, the number of pages, creation date, updating date, access date, and index.

The document management server 110 may acquire in step S802 attribute data, print setting information, and thumbnail image information (so-called thumbnail image data) of a document that are stored in association with the acquired folder ID, and transmit list information on pieces of document addition information each containing attribute data, print setting information, and thumbnail image information to the digital multifunction peripheral 130 in step S803.

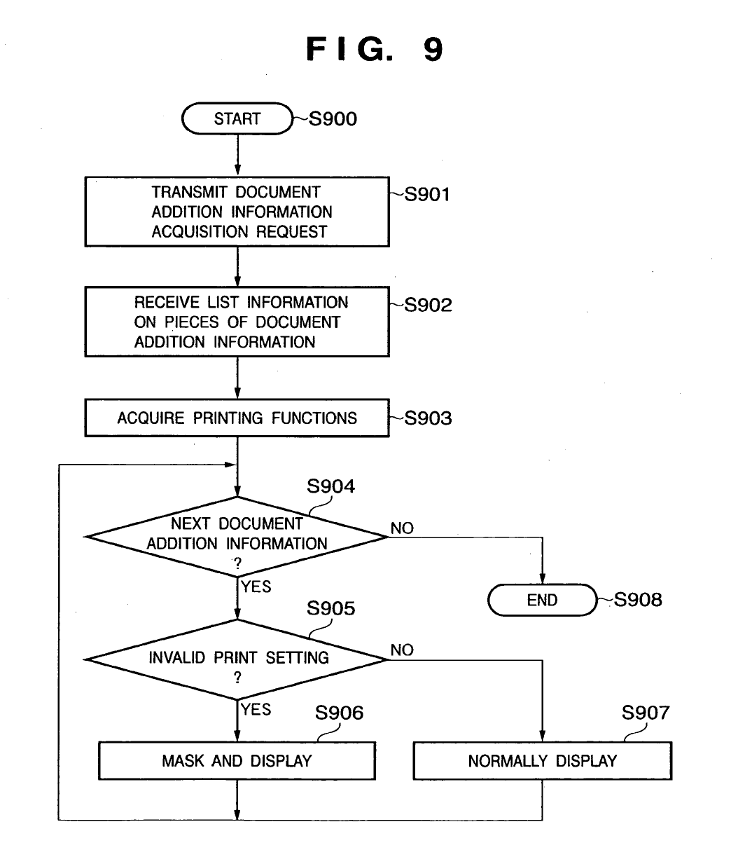

Operation of a document information listing process in the digital multifunction peripheral 130 will be explained with reference to the flowchart of FIG. 9.

When the operator selects a desired folder on the operation window, the digital multifunction peripheral 130 starts the process (step S900), and transmits a document addition information acquisition request command to the document management server 110 on the basis of the folder ID of the selected folder (step S901). As the response command, the digital multifunction peripheral 130 receives, from the document management server 110, list information on pieces of document addition information each containing attribute data and print setting information (step S902). The digital multifunction peripheral 130 acquires printing function information of the digital multifunction peripheral representing the number of finishers and whether printing functions (e.g., double-sided printing, rotation, shift, stapling, saddle stitch, punching, Z-folding, and insertion of an index sheet) are available (step S903). The digital multifunction peripheral 130 determines whether document addition information which does not undergo processes in steps S904 to S907 yet remains in the acquired list information on pieces of document addition information (step S904). If unprocessed document addition information is found, the process advances to step S905 to determine whether there is an invalid print setting, on the basis of print setting information of the document addition information and printing function information of the digital multifunction peripheral.

An “invalid print setting” means a print setting which is registered for a document in a folder in the document management server 110 and cannot be implemented by the digital multifunction peripheral 130 that displays the document. When a folder containing a document having a double-sided printing setting is selected on the operation window of the digital multifunction peripheral 130 having no double-sided printing function, the double-sided printing setting of the document is determined to be an “invalid print setting”.

If an invalid print setting is found, the digital multifunction peripheral 130 masks and displays attribute data of the document addition information (step S906). If no invalid print setting is found, the digital multifunction peripheral 130 normally displays the attribute data of the document addition information (step S907). The digital multifunction peripheral 130 repeats processes in steps S904 to S907 for all pieces of document addition information in the acquired list information. If no unprocessed document addition information is found in step S904, the process ends (step S908).

The digital multifunction peripheral 130 may receive, from the document management server, list information on pieces of document addition information each containing attribute data, print setting information, and thumbnail image information in step S902, mask and display the attribute data and thumbnail image information of the document addition information in step S906, and normally display the attribute data and thumbnail image information of the document addition information in step S907.

In short, the digital multifunction peripheral 130 as a kind of image processing apparatus comprises the operation unit 134 and controller unit 133 serving as display unit adapted for listing and displaying documents managed in the document management server 110, and the printer 132 serving as a print unit adapted for selectively printing documents displayed on the LCD display unit 600 of the operation unit 134. The controller unit 133 compares print settings added to documents managed in the document management server 110 with the printing functions of the printer 132, and displays identifiably from other documents a document to which a print setting unimplementable by the printing functions of the printer is added. This facilitates determination of whether there is a print setting which becomes invalid when desired document information is printed by the digital multifunction peripheral.

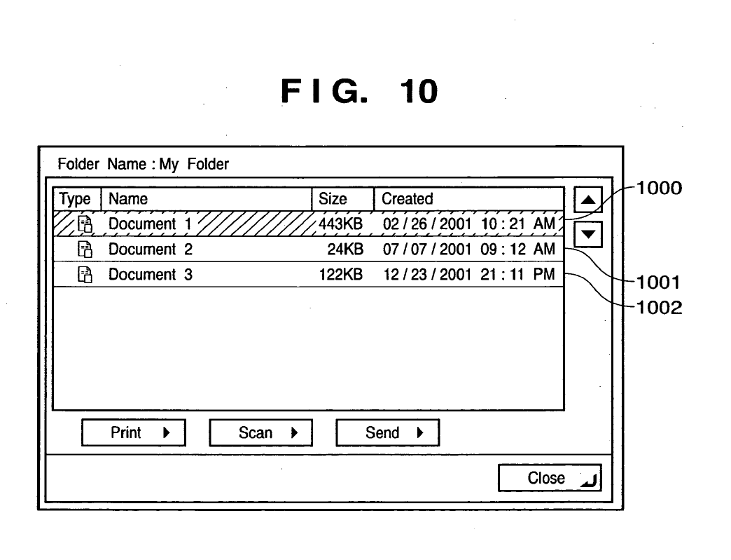

FIG. 10 shows an example of the display window of attribute data of a document in the document information listing process. In FIG. 10, pieces of document information 1000, 1001, and 1002 stored in the document management server are displayed each with the type of attribute data, document name, size, and creation date on the LCD display unit 600 of the digital multifunction peripheral 130, and the document information 1000 having an invalid print setting is masked and displayed.

In FIG. 10, a document to which a print setting unimplementable by the printing functions of the printer 132 is added is displayed identifiably from other documents in listing and displaying document attribute data. The user can confirm whether print settings added in advance to a document can be implemented by the digital multifunction peripheral 130 while confirming attribute data. A user-friendly digital multifunction peripheral can be implemented.

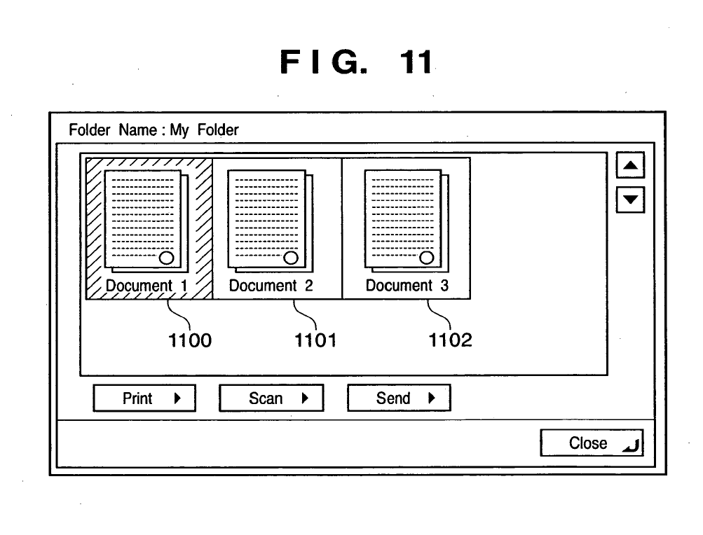

FIG. 11 shows an example of the display window of attribute data and thumbnail image information of a document in the document information listing process. In FIG. 11, pieces of document information 1100, 1101, and 1102 stored in the document management server are displayed each with the document name of attribute data and thumbnail image information on the operation window of the digital multifunction peripheral, and the document information 1100 having an invalid print setting is masked and displayed.

In FIG. 11, a document to which a print setting unimplementable by the printing functions of the printer 132 is added is displayed identifiably from other documents in listing and displaying the thumbnail images of documents. The user can confirm whether print settings added in advance to a document can be implemented by the digital multifunction peripheral 130 while roughly confirming the print result of the document. A user-friendly digital multifunction peripheral can be implemented.

### Second Embodiment

A network document management system according to the second embodiment of the present invention will be described. The network document management system of the second embodiment is different from the first embodiment in that an icon about a print setting is displayed together with the thumbnail image of document information when the document information is displayed as the thumbnail image. The icon identifiably presents which print setting becomes invalid. The second embodiment is slightly different from the first embodiment in only data exchanged between a document management server and a digital multifunction peripheral and a display process using the data. The remaining hardware configuration and functions are the same as those in the first embodiment, the same reference numerals denote the same parts, and a description thereof will be omitted.

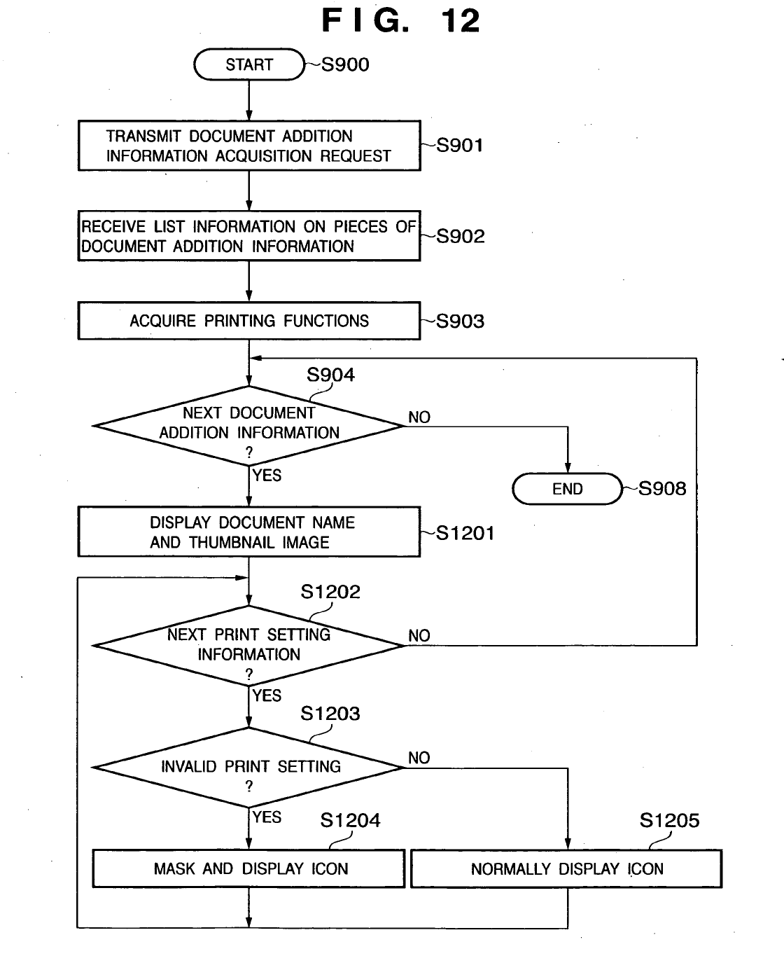

As a difference from the first embodiment, operation of a document information listing process in the digital multifunction peripheral according to the second embodiment will be explained with reference to the flowchart of FIG. 12. This flowchart corresponds to the flowchart of FIG. 9 described in the first embodiment, and includes the same processes. The same reference numerals denote the same processes, and a description thereof will be omitted.

For unprocessed document addition information, the digital multifunction peripheral displays a document name represented by attribute data of the document addition information and thumbnail image information of the document addition information (step S1201). The digital multifunction peripheral determines whether print setting information which does not undergo processes in steps S1203 to S1205 yet remains in print setting information of the document addition information (step S1202). If unprocessed print setting information is found, the digital multifunction peripheral 130 determines whether a print setting represented by the print setting information becomes invalid, on the basis of the print setting information and printing function information of the digital multifunction peripheral (step S1203). If the print setting becomes invalid, the digital multifunction peripheral masks and displays an icon representing the print setting (step S1204). If the print setting is valid, the digital multifunction peripheral normally displays the icon representing the print setting (step S1205). The digital multifunction peripheral repeats processes in steps S1203 to S1205 for all pieces of print setting information of the document addition information. If no unprocessed print setting information is found in step S1202, the process returns to step S904. The digital multifunction peripheral repeats processes in steps S904 to S1205 for all pieces of document addition information in the acquired list information. If no unprocessed document addition information is found in step S904, the process ends (step S908).

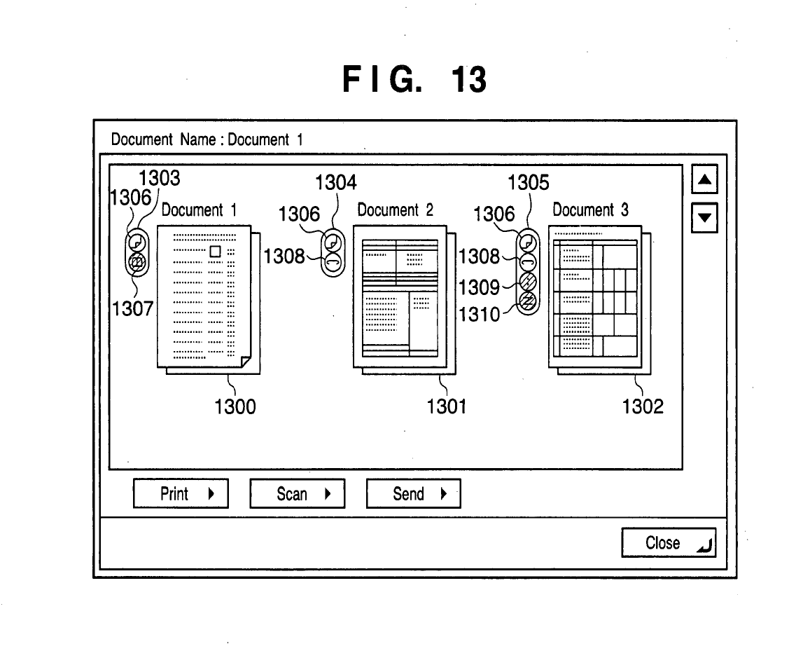

FIG. 13 shows an example of the display window of the document information listing process. In FIG. 13, pieces of document information 1300, 1301, and 1302 managed in the document management server are displayed on the operation window of the digital multifunction peripheral with document names, thumbnail image information, and icon groups 1303, 1304, and 1305 representing print settings. An icon 1306 representing a printing method setting such as single-sided printing or double-sided printing, and an icon 1308 representing a stapling setting are normally displayed as valid print settings. An icon 1307 representing a saddle stitch setting, an icon 1309 representing a punching setting, and an icon 1310 representing a Z-folding setting are masked and displayed as invalid print settings.

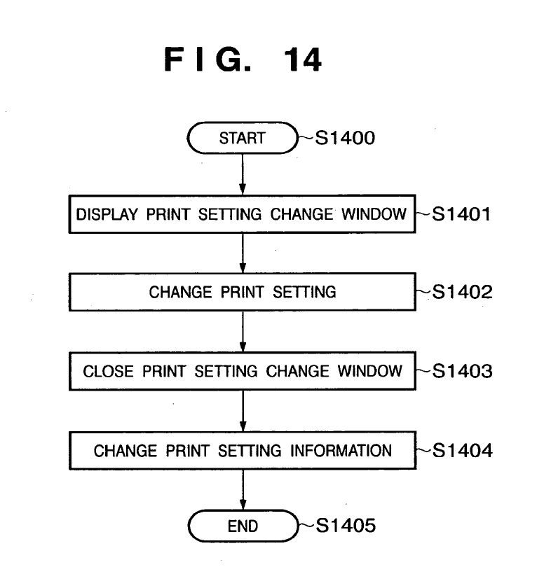

Operation of a print setting change process in the digital multifunction peripheral will be explained with reference to the flowchart of FIG. 14.

When the operator selects a desired print setting icon on the operation window, the digital multifunction peripheral starts the process (step S1400). The digital multifunction peripheral displays a print setting change window for changing the print setting on the basis of the selected print setting icon (step S1401). The digital multifunction peripheral accepts change of the print setting by the operator on the print setting change window (step S1402), and closes the print setting change window upon the completion of change operation (step S1403). The digital multifunction peripheral changes print setting information designated by the print setting icon to the print setting changed by the operator (step S1404), and the process ends (step S1405).

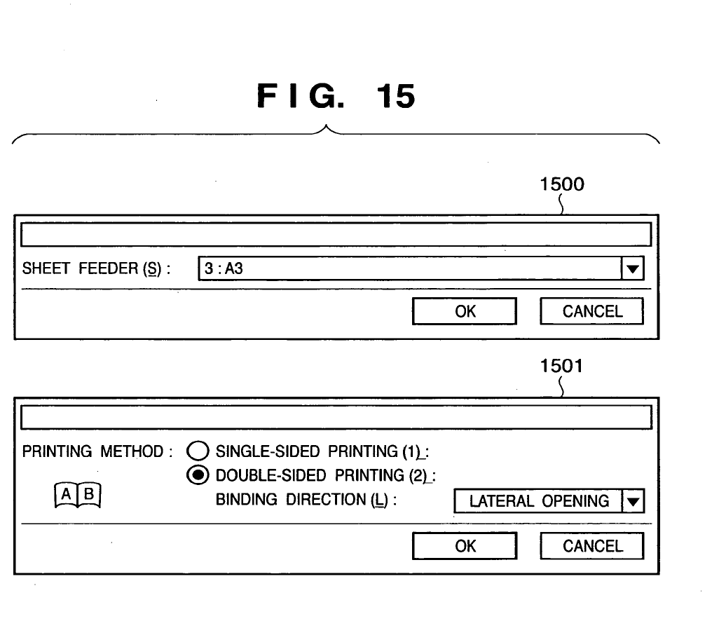

FIG. 15 shows an example of the print setting change display window in the print setting change process. FIG. 15 illustrates a window 1500 which is displayed to change the setting (sheet feed size) of the sheet feeder when a sheet feeder setting icon is selected, and a window 1501 which is displayed to change the setting of the printing method when a printing method setting icon is selected.

As described above, a digital multifunction peripheral 130 according to the second embodiment displays a print setting which cannot be implemented by the printing functions of a printer 132, identifiably from print settings which can be implemented by the printing functions of the printer 132. Which print setting cannot be implemented when printing is executed can be easily confirmed with high convenience when documents are listed and displayed.

Since print settings are displayed as icons, invalid print settings and valid print settings can be effectively identifiably displayed in a limited display window. Since a desired print setting can be selected and changed, an invalid print setting can be easily changed in document information having the invalid print setting.

### Third Embodiment

A network document management system according to the third embodiment of the present invention will be described. The network document management system of the third embodiment is different from the first and second embodiments in that whether an invalid print setting exists is determined for each page, and a page having an invalid print setting and a page having no invalid print setting are identifiably displayed. The third embodiment is slightly different from the first embodiment in only data exchanged between a document management server and a digital multifunction peripheral and a display process using the data. The remaining hardware configuration and functions are the same as those in the first embodiment, the same reference numerals denote the same parts, and a description thereof will be omitted.

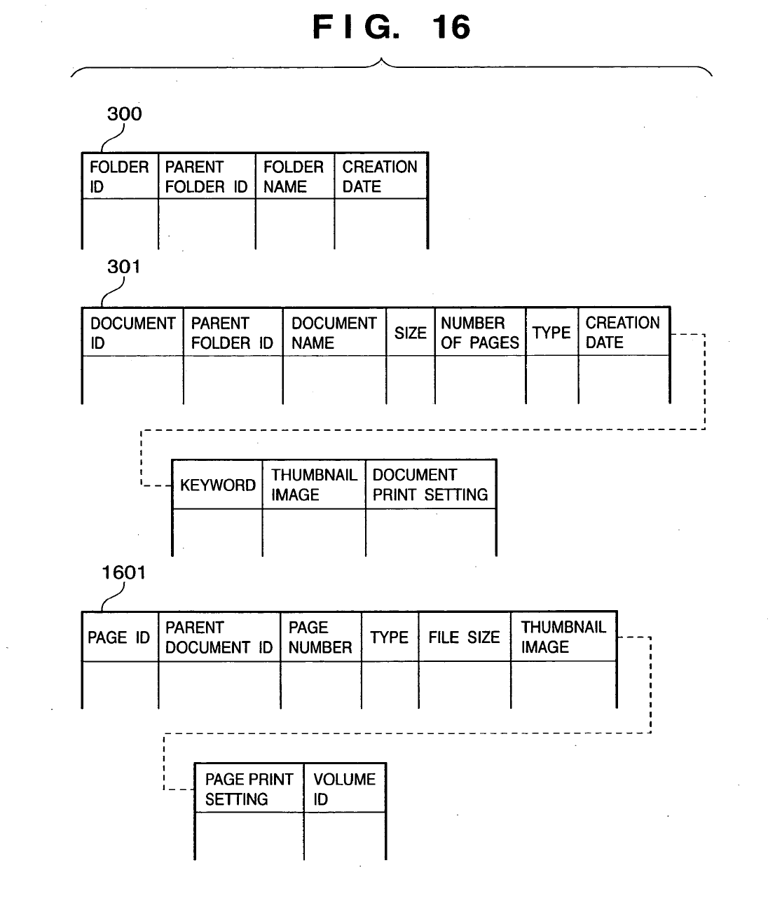

FIG. 16 shows an example of the table definition of an attribute storage unit 114 according to the third embodiment. FIG. 16 corresponds to FIG. 3 described in the first embodiment. The table definition in FIG. 16 is different from that in FIG. 3 in that thumbnail image data of a page and print settings of the page are registered in a page management table 1602 in addition to the page ID, parent document ID, page number, page type, file size, and volume ID. These print settings are page print settings, and include sheet feed method information such as the paper size and medium type and image quality information such as the color mode and smoothing.

In accordance with a request from an application unit 701, a job control domain unit 702 (see FIG. 7) according to the third embodiment supplies, to the application unit 701, printing function information representing the availability/unavailability and available range of printing functions of each document (e.g., double-sided printing, bookbinding printing, rotation, shift, stapling, saddle stitch, punching, and Z-folding), and those of printing functions of each page (e.g., paper size, medium type, color mode, and smoothing). In step S905 of FIG. 9, the application unit 701 compares print setting information contained in document addition information with printing function information acquired in step S903, and determines whether an invalid print setting is found.

If an invalid print setting is found, document information having no invalid print setting and document information having an invalid print setting are identifiably listed and displayed, similar to the first and second embodiments (FIGS. 10, 11, and 13).

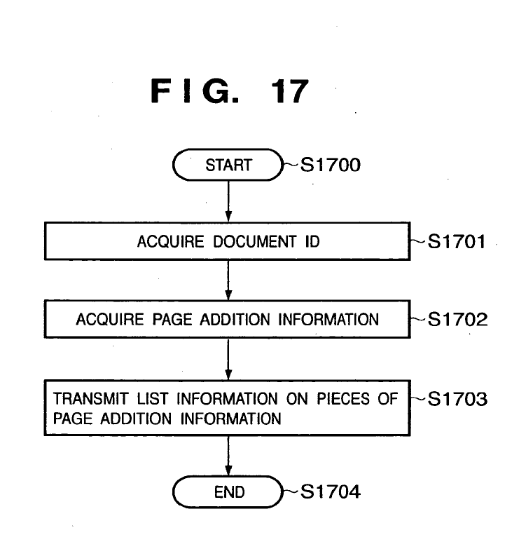

Operation of a page addition information acquisition/response process in the document management server will be explained with reference to the flowchart of FIG. 17.

The document management server starts the process upon reception of a page addition information acquisition request command from the digital multifunction peripheral (step S1700). The document management server acquires a document ID from the command (step S1701). The document management server acquires attribute data, print setting information, and thumbnail image information of a page that are stored in association with the acquired document ID (step S1702). As a response command to the page addition information acquisition request command received in step S1700, the document management server transmits, to the digital multifunction peripheral, list information on pieces of page addition information each containing attribute data, print setting information, and thumbnail image information of a page (step S1703). Then, the process ends (step S1704).

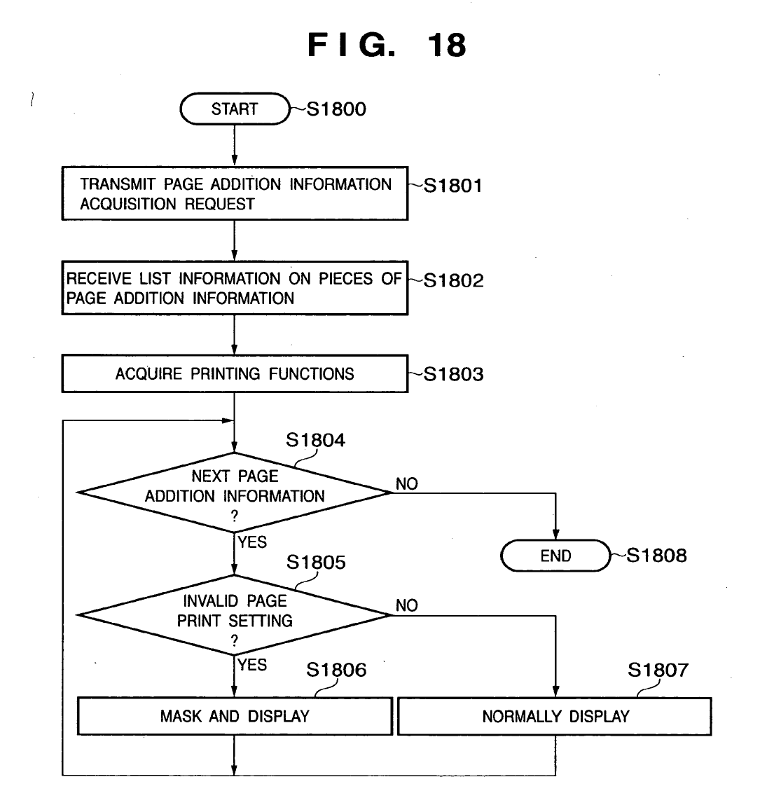

Operation of a page information listing process in the digital multifunction peripheral when page information having no invalid page print setting and page information having an invalid page print setting are identifiably listed and displayed will be explained with reference to the flowchart of FIG. 18.

When the operator selects a desired document on the operation window, the digital multifunction peripheral starts the process (step S1800). The digital multifunction peripheral transmits a page addition information acquisition request command to the document management server on the basis of the document ID of the selected document (step S1801). As the response command, the digital multifunction peripheral receives, from the document management server, list information on pieces of page addition information each containing attribute data, print setting information, and thumbnail image information of a page (step S1802). The digital multifunction peripheral acquires printing function information of the digital multifunction peripheral that represents, for example, the availability/unavailability and available range of printing functions (e.g., double-sided printing, bookbinding printing, rotation, shift, stapling, saddle stitch, punching, Z-folding, paper size, medium type, color mode, and smoothing) (step S1803). The digital multifunction peripheral determines whether page addition information which does not undergo processes in steps S1804 to S1807 yet remains in the acquired list information on pieces of page addition information (step S1804). If unprocessed page addition information is found, the digital multifunction peripheral determines whether there is an invalid print setting, on the basis of print setting information of the page addition information and printing function information of the digital multifunction peripheral (step S1805). If an invalid print setting is found, the digital multifunction peripheral masks and displays attribute data, invalid print setting information, and thumbnail image information of the page addition information (step S1806). If no invalid print setting is found, the digital multifunction peripheral normally displays the attribute data and thumbnail image information of the page addition information (step S1807). The digital multifunction peripheral repeats processes in steps S1804 to S1807 for all pieces of page addition information in the acquired list information. If no unprocessed page addition information is found in step S1804, the process ends (step S1808).

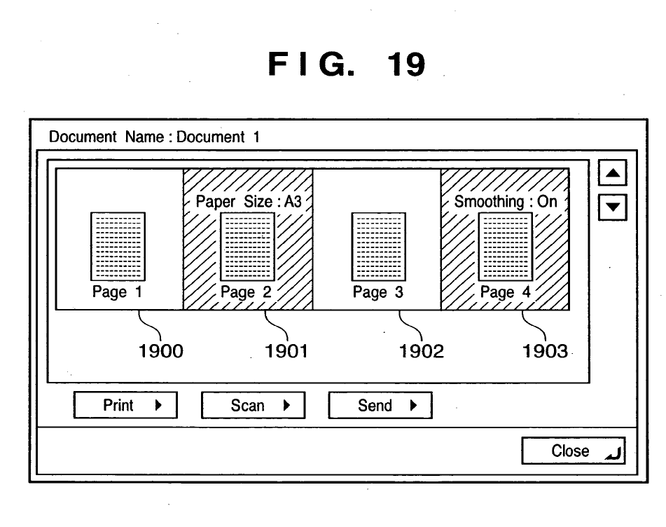

FIG. 19 shows an example of the display window of attribute data, print setting information, and thumbnail image information of each page in the page information listing process. In FIG. 19, pieces of page information 1900, 1901, and 1902 stored in the document management server are displayed each with the page number of attribute data, invalid print setting information, and thumbnail image information on the operation window of the digital multifunction peripheral, and pieces of page information having invalid print settings are masked and displayed. At this time, similar to the second embodiment, an invalid print setting and valid print setting may be identifiably displayed by icons.

Page icons contained in a document may be displayed as threads of the document icon, and the user may be notified of the presence/absence of an invalid print setting by masking and displaying a corresponding one of the icons. Further, print setting icons of a page may be displayed as threads of each page icon, and the user may be notified which print setting is invalid, by masking and displaying a corresponding one of the print setting icons.

In the third embodiment, a controller unit 133 serving as a display unit compares print settings added to a document managed in a document management server 110 with the printing functions of a printer 132, and displays identifiably from other pages a page to which a print setting unimplementable by the printing functions of the printer 132 is added. This facilitates determination of page information having an invalid print setting in document information having an invalid print setting, and a more convenient digital multifunction peripheral can be provided.

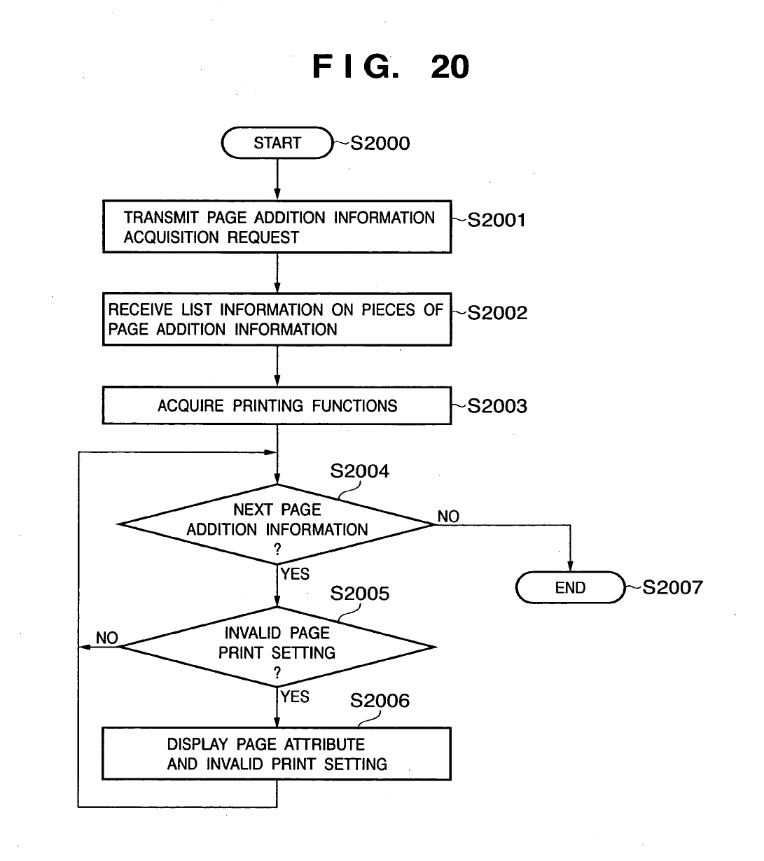

Operation of a page information listing process in the digital multifunction peripheral when only page information having an invalid page print setting is listed and displayed will be explained with reference to the flowchart of FIG. 20.

When the operator selects a desired document on the operation window, the digital multifunction peripheral starts the process (step S2000). The digital multifunction peripheral transmits a page addition information acquisition request command to the document management server on the basis of the document ID of the selected document (step S2001). As the response command, the digital multifunction peripheral receives, from the document management server, list information on pieces of page addition information each containing attribute data and print setting information of a page (step S2002). The digital multifunction peripheral acquires printing function information of the digital multifunction peripheral that represents, for example, the availability/unavailability and available range of printing functions (e.g., double-sided printing, bookbinding printing, rotation, shift, stapling, saddle stitch, punching, Z-folding, paper size, medium type, color mode, and smoothing) (step S2003). The digital multifunction peripheral determines whether page addition information which does not undergo processes in steps S2004 to S2006 yet remains in the acquired list information on pieces of page addition information (step S2004). If unprocessed page addition information is found, the digital multifunction peripheral determines whether there is an invalid print setting, on the basis of print setting information of the page addition information and printing function information of the digital multifunction peripheral (step S2005). If an invalid print setting is found, the digital multifunction peripheral displays attribute data and invalid print setting information of the page addition information (step S2006). If no invalid print setting is found, the digital multifunction peripheral returns to step

S2004 without performing any process. The digital multifunction peripheral repeats processes in steps S2004 to S2006 for all pieces of page addition information in the acquired list information. If no unprocessed page addition information is found in step S2004, the process ends (step S2007).

In executing the page information listing process, attribute data and print setting information of a page that are stored in association with an acquired document ID are acquired in step S1702. In step S1703, list information on pieces of page addition information each containing the attribute data and print setting information of a page is transmitted to the digital multifunction peripheral.

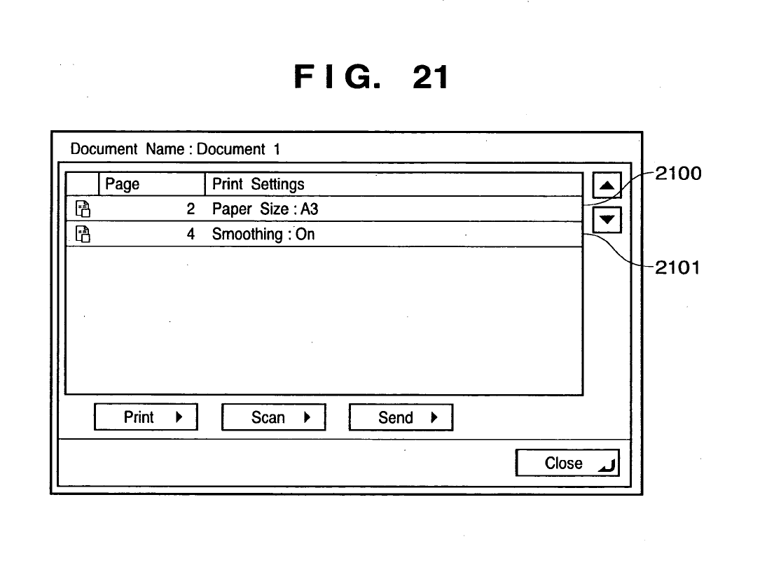

FIG. 21 shows an example of the display window of attribute data and print setting information of each page in the page information listing process. In FIG. 21, pieces of page information 2100 and 2101 having invalid print settings are displayed each with the page number of attribute data and invalid print setting information on the operation window of the digital multifunction peripheral.

As described with reference to FIGS. 20 and 21, a digital multifunction peripheral 130 according to the third embodiment compares print settings added to a document managed in the document management server 110 with the printing functions of the printer 132, and extracts and displays only pages to which print settings unimplementable by the printing functions of the printer 132 are added. Then, attribute data of the pages are listed and displayed. The user can clearly confirm only pages each having an invalid print setting, and simultaneously confirm attribute data.

### Other Embodiments

Though the embodiment of the present invention has been detailed above, the invention may be applied to a system constituted by a plurality of devices, or an apparatus comprising a single device.

Further, the invention can be implemented by supplying a software program, which implements the functions of the foregoing embodiments, directly or remotely to a system or apparatus, reading the supplied program code with a computer of the system or apparatus, and then executing the program code. Accordingly, since the functions of the present invention are implemented by computer, the program code installed in the computer is also included within a technical scope of the present invention.

In this case, so long as the system or apparatus has the functions of the program, the program may be executed in any form, such as an object code, a program executed by an interpreter, or scrip data supplied to an operating system.

Examples of storage media that can be used for supplying the program are a floppy disk, a hard disk, an optical disk, a magneto-optical disk, an MO, a CD-ROM, a CD-R, a CD-RW, a magnetic tape, a non-volatile type memory card, a ROM, and a DVD (DVD-ROM and DVD-R).

As for the method of supplying the program, a client computer can be connected to a home page on the Internet using a browser of the client computer, and the computer program of the present invention or an automatically-installable compressed file of the program can be downloaded from the home page to a recording medium such as a hard disk. Further, the program of the present invention can be supplied by dividing the program code constituting the program into a plurality of files and downloading the files from different home pages. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a home page via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing according to the instructions of the program, so that the functions of the foregoing embodiments can be implemented by this processing.

Further, after the program read from the storage medium is written to a function expansion board inserted into the computer or to a memory provided in a function expansion unit connected to the computer, a CPU or the like mounted on the function expansion board or function expansion unit performs all or a part of the actual processing according to the instructions of the program, so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### Claim Of Priority

This application claims priority from Japanese Patent Application No. 2004-210381 filed on Jul. 16, 2004, the entire contents of which are hereby incorporated by reference herein.

1. An image processing apparatus comprising:
a display unit adapted for displaying information for identifying documents managed in a document management server;
a print unit adapted for selectively printing at least one of the documents managed in the document management server; and
a controller for comparing print settings added to the documents managed in the document management server with a printing function of said print unit,
wherein said display unit displays information for identifying a document to which a print setting unimplementable by the printing function of said print unit is added, identifiably from a document to which a print setting unimplementable by the printing function of said print unit is not added.

2-11. (canceled)
